(19) United States
(12) Patent Application Publication
(10) Pub. No.: US 2009/0236552 A1
(43) Pub. Date: Sep. 24, 2009

(54) Flow control valve

(75) Inventors: Tetsuya Akagi, Tsuyama-shi (JP); Shujiro Dohta, Okayama-shi (JP); Shinichi Katayama, Kurashiki-shi (JP); Kenichi Kurosawa, Kashiwa-shi (JP)

Correspondence Address: Yokoi & Company U.S.A., INC., 13700 Marina Pointe Drive, Suite #723, Marina Del Rey, CA, 90292, US

(73) Assignee: SMC Corporation, Tokyo (JP)

(21) Appl. No.: 12/290,514

(22) Filed: Oct. 31, 2008

(30) Foreign Application Priority Data
Mar. 18, 2008 (JP) JP2008-070482

(51) Int. Cl. F16K 5/06

(52) U.S. Cl. 251/315.01

(57) ABSTRACT

The present invention provides a flow control valve that requires only a relatively small opening/closing drive force, is compact and does not induce a pulsating flow in the valve open state. A valve seat (3) is disposed in a pipeline (5) through which a fluid flows. A spherical valve element (12) assuming a diameter smaller than the inner diameter of the pipeline (5) is housed inside the pipeline (5). A vibrating motor (8), which eccentrically rotates the valve element (12) kept in contact with the inner wall of the pipeline (5) is disposed outside the pipelines (5) and (6).

### TECHNICAL FIELD

The present invention relates to a flow control valve via which the flow of a fluid is controlled and more specifically, it relates to a compact flow control valve.

### BACKGROUND ART

Flow control valves in the related art used for ON/OFF control and the like for the flow of a fluid such as air, include the flow control valve disclosed in Japanese Laid Open Patent Publication No. 2000-9246. The flow control valve includes a valve element drive member inserted in a pipeline and a drive device such as a coil disposed outside the pipeline. In this flow control valve, a plunger disposed inside the pipeline is driven against the flow (pressure) of the fluid by using an electromagnetic force generated at the coil disposed outside the pipeline, so as to move the valve element away from the valve seat, thereby opening the valve. A flow control valve adopting such a structure assures a high level of gas/liquid tightness.

Another example of a flow control valve in the related art, which can be opened/closed from the outside, adopts a vibration method as disclosed in Japanese Laid Open Patent Publication No. 2006-342856. At the flow control valve adopting the vibration method, a gap is created between the valve seat and the valve element by vibrating the valve seat with a piezoelectric element, a solenoid or the like, so as to adjust the flow rate. Japanese Laid Open Patent Publication No. 2006-342856 discloses that the valve seat vibrates in response to an operation performed outside the pipeline.

### DISCLOSURE OF THE INVENTION

At a flow control valve assuming a structure in which a plunger is driven with the electromagnetic force generated by a coil such as that disclosed in Japanese Laid Open Patent Publication No. 2000-9246, the level of fluid force applied to the valve element changes greatly during a valve opening/closing operation. This necessitates that the coil and the plunger be relatively large or massive compared to the valve seat undergoing the opening/closing operation, in order to withstand the fluid force.

A flow control valve adopting the valve seat vibration method, such as that disclosed in Japanese Laid Open Patent Publication No. 2006-342856, at which the valve seat is caused to vibrate along the flow direction, requires a relatively large or massive coil or piezoelectric element in comparison to the valve seat undergoing the opening/closing operation, so as to withstand the fluid pressure, as in the case of the flow control valve disclosed in Japanese Laid Open Patent Publication No. 2000-9246 mentioned earlier. In addition, as the valve seat vibrates, a pulsating flow occurs on the downstream side of the flow control valve. Such a pulsating flow will hinder smooth movement of the drive target member driven on the downstream side of the valve.

An object of the present invention, having been completed by addressing the issues discussed above, is to provide a flow control valve equipped with an opening/closing drive force generation device disposed outside a pipeline, which requires only a relatively low level of opening/closing drive force, can be provided as a compact unit and does not induce a pulsating flow in a valve open state.

The flow control valve according to the present invention comprises:

a valve seat disposed inside a pipeline through which a fluid flows;

a spherical valve element housed inside the pipeline and assuming a diameter smaller than the inner diameter of the pipeline, with which a valve hole at the valve seat can be closed or opened; and

a rotational drive device disposed outside the pipeline which opens the valve hole at the valve seat by causing eccentric rotation of the valve element kept in contact with an inner wall of the pipeline.

The rotational drive device in the flow control valve according to the present invention is constituted with a vibrating motor that causes eccentric rotation of the valve element by eccentrically rotating the pipeline.

The flow control valve according to the present invention further comprises a stopper that regulates the distance by which the valve element is set apart from the valve seat, disposed inside the pipeline.

At the flow control valve according to the present invention, the spherical valve element is made to move away from the valve hole so as to open the valve as the valve element, maintaining contact with the inner wall of the pipeline, eccentrically rotates. As a result, the valve can be opened with a relatively small force required to move the valve element away from the axial center, compared to the force required to displace the valve element against the fluid pressure. This, in turn, makes it possible to provide the valve as a more compact unit. In addition, since the valve hole remains open while the valve element rotates eccentrically, no pulsating flow occurs on the downstream side of the flow control valve according to the present invention. Consequently, pulsation or the like of the drive target member due to such a pulsating flow does not occur.

By constituting the rotational drive device with a vibrating motor, the flow control valve according to the present invention can be configured without having to dispose a plunger or a vibrating member inside the pipeline. Instead, the flow control valve assuming a simple structure can be manufactured with greater ease, simply by disposing the valve element and the valve seat inside the pipeline through which the fluid flows and installing the vibrating motor outside the pipeline.

By installing a stopper for regulating the distance by which the valve element is set apart from the valve seat within the pipeline, the length of time to elapse before the valve element becomes seated at the valve seat to close the valve is reduced and thus, the flow control valve according to the present invention can be provided as a quick-response unit.

### BRIEF DESCRIPTION OF THE DRAWINGS

FIG. 1 is a sectional view showing part of the flow control valve according to the present invention achieved in an embodiment, taken over a side surface thereof;

FIG. 2 is a sectional view taken along E-E in FIG. 1;

FIG. 3 is a sectional view of the flow control valve in the valve open state;

FIG. 4 is a sectional view taken along F-F in FIG. 3;

FIG. 5 is a sectional view showing part of the flow control valve according to the present invention achieved in another embodiment, taken over a side surface thereof;

FIG. 6 is a sectional view showing part of the flow control valve according to the present invention achieved in yet another embodiment, taken over a side surface thereof; and

FIG. 7 is a sectional view showing part of the flow control valve according to the present invention achieved in yet another embodiment, taken over a side surface thereof.

### BEST MODE FOR CARRYING OUT THE INVENTION

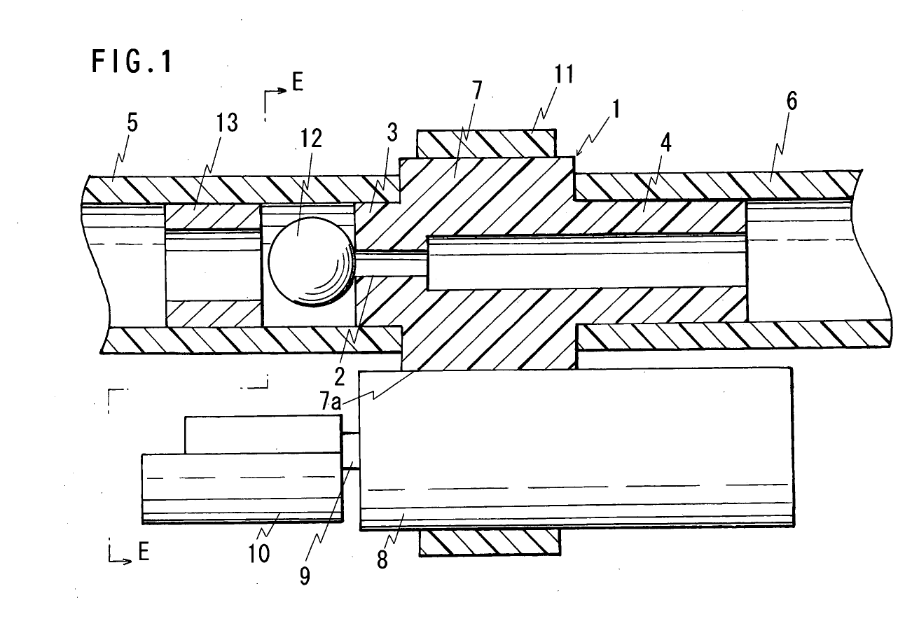

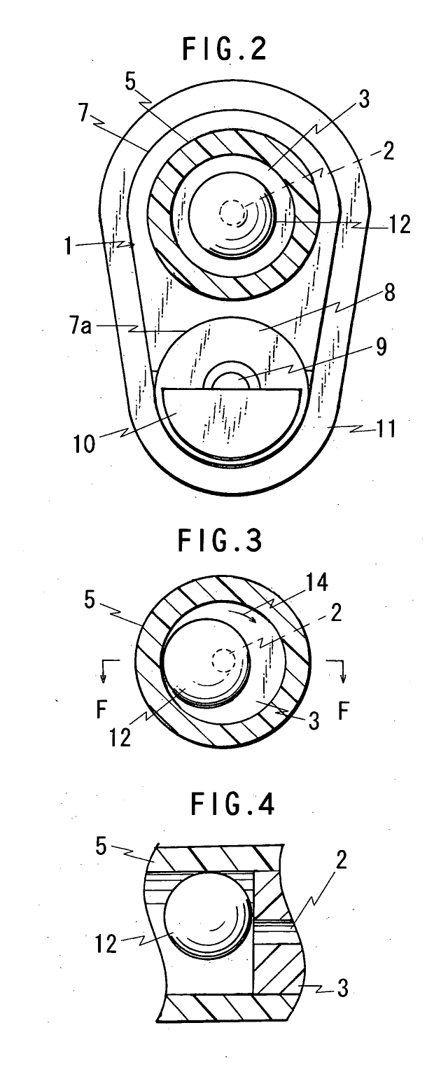

FIG. 1 is a sectional view showing part of the flow control valve according to the present invention achieved in an embodiment, taken over a side surface thereof and FIG. 2 is a sectional view taken along E-E in FIG. 1. Reference numeral 1 indicates a valve main unit, with a valve seat 3 having formed therein a valve hole 2 formed at one end of the valve main unit 1. In addition, a pipeline 4 assuming an opening diameter greater than the diameter of the valve hole 2 is formed on the downstream side of the area of the valve main unit 1 where the valve hole 2 is present. The valve main unit 1 may be constituted of a hard synthetic resin, such as acrylic resin, or metal.

Reference numeral 5 indicates an upstream-side pipeline extending on the upstream-side of the valve, whereas reference numeral 6 indicates a downstream-side pipeline extending on the downstream side of the valve. The pipelines 5 and 6 may be constituted with a deformable resin such as polyurethane resin. The upstream-side pipeline 5 is fitted at the outer periphery of the valve seat 3 located at one end of the valve main unit 1 and is fixed onto the outer periphery of the valve seat 3 through welding or bonding. The downstream-side pipeline 6 is fitted into the pipeline 4 at the valve main unit 1 and is fixed onto the outer periphery of the pipeline 4 through welding or bonding.

The valve main unit 1 includes a drive device mount portion 7 located over a middle area thereof and assuming a large diameter. The drive device mount portion 7 includes a recess 7a such as that shown in FIG. 2, at which a vibrating motor 8 used as a drive device, is fitted and mounted. The vibrating motor 8 is constituted with an output shaft 9 and an eccentric weight 10 mounted at the output shaft. The vibrating motor 8 is fitted inside the recess 7a of the drive device mount portion 7 and is fixed at the drive device mount portion 7 with a band 11 which, together with the vibrating motor 8, is wound around the drive device mount portion 7. Namely, the vibrating motor 8 is installed so that its output shaft 9 ranges parallel to the valve main unit 1 and the pipelines 5 and 6. Alternatively, the vibrating motor 8 may be fixed onto the drive device mount portion 7 with bolts or through bonding.

Reference numeral 12 indicates a spherical valve element constituted of a metal such as steel or hard resin. The valve element 12 is housed inside the upstream-side pipeline 5. The valve element 12 assumes a diameter smaller than the inner diameter of the upstream-side pipeline 5. Reference numeral 13 indicates a stopper disposed inside the pipeline 5 in order to prevent the valve element 12 from moving too far away from the valve seat 3 along the flow direction. The stopper 13 assumes a tubular shape with the inner diameter thereof set slightly smaller than the outer diameter of the valve element 12.

It is to be noted that the pipelines 5 and 6 assume an inner diameter of 2.5 mm and an outer diameter of 4 mm, that the valve hole 2 assumes a diameter of 0.5 mm, that the valve element 12 assumes a diameter of 2.0 mm and that the distance measured from the stopper 13 to the end of the pipeline 4 is 20 mm in the embodiment. In addition, the width of the area that includes the mount portion 7 and the vibrating motor 8 is 10 mm and the length of the vibrating motor 8 including the eccentric weight 10 is 20 mm. The overall size of the flow control valve, including the vibrating motor 8, the valve main unit 1, the stopper 13, the pipeline 4 and the pipelines 5 and 6 present around the pipeline 4 is equivalent to approximately 1 cc.

The flow control valve structured as described above is engaged in operation by supporting the pipelines 5 and 6 over areas thereof away from the valve main unit 1 and lifting the valve main unit 1 and the vibrating motor 8. When the vibrating motor 8 is not being driven, the valve element 12 is pressed toward the valve seat 3 with the pressure of the fluid such as air, and thus, the valve element 12 closes off the valve hole 2 as shown in FIGS. 1 and 2. If vibration manifesting as an impulse is applied in the valve closed state, the valve element 12 may become displaced to open the valve. However, the valve element 12 will immediately move back to the center of the pipeline 5 due to the fluid pressure and closes off the valve hole 2. In other words, even in the event of an external disturbance, the valve does not remain in the open state for long.

As the vibrating motor 8 is driven and the eccentric weight 10 rotates, the vibrating motor 8 is engaged in eccentric rotation around its axial center. As a result, the valve main unit 1 also rotates eccentrically together with the vibrating motor 8. This, in turn, causes the pipelines 5 and 6 to rotate eccentrically together with the valve main unit 1. The eccentric rotation causes the valve element 12 to depart the valve hole 2 and rotate eccentrically while sustaining contact with the inner wall of the pipeline 5, as shown in arrow 14 in FIGS. 3 and 4. The valve thus enters the open state.

The valve hole 2 remains open as long as the valve element 12 rotates eccentrically at the flow control valve. In other words, the valve hole 2 remains open over a constant opening area at all times while the valve element 12 rotates eccentrically. Thus, a pulsating flow such as that which tends to occur at a flow control valve that enters the valve open state in response to vibration of the valve seat, does not occur.

In addition, since the valve opens in response to the eccentric rotation of the valve element 12, the force with which the valve element 12 is opened works along a direction perpendicular to the direction of the fluid flow at the flow control valve. Thus, the valve element 12 can be opened with a small force compared to that required to open the valve element by displacing the valve element against the flow of the fluid at a flow control valve in the related art. The flow control valve according to the present invention, which requires a lower level of drive force to be used to open the valve, can be provided as a more compact unit.

In more specific terms, an electromagnetic valve in the related art used to constitute a valve via which a fluid, e.g., air, is supplied with a pressure of approximately 50 kPa˜500 kPa at a flow rate of 2 L/min˜15 L/min would have to weigh 15˜20 g and assume a size of 15˜25 cc. The flow control valve in the embodiment, on the other hand, can be provided as a compact unit waiting 2 g and assuming a size of approximately 1 cc, as explained earlier. In other words, the flow control valve according to the present invention can be provided as a very compact, lightweight unit, weighing approximately 1/10˜ 1/7.5 of a flow control valve in the related art and assuming a size 1/25˜ 1/15 of the flow control valve in the related art.

The flow control valve according to the present invention provided as a compact unit is ideal in certain applications. For instance, it is ideal in artificial muscle applications, whereby a plurality of extensible/contractible tubes are fitted around an arm, a leg or the like of a person. Namely, the flow control valve according to the present invention may be used as a valve via which pressurized air is delivered into/discharged from a tube constituting an artificial muscle. In addition, the flow control valve according to the present invention may replace an electromagnetic valve in the related art as a compact flow control valve assuring a superior seal. The flow control valve according to the present invention is particularly ideal in applications in which batteries are used as the power source for opening/closing compact flow control valves.

In addition, the embodiment includes the stopper 13 that regulates the distance by which the valve element 12 moves away from the valve seat 3 and thus, the valve element 12 remains in close proximity to the valve seat 3 even in the valve open state. As a result, as soon as the vibrating motor 8 stops, the valve element 12 promptly moves back toward the valve seat 3 due to the pressure of the fluid, to enable speedy valve switching.

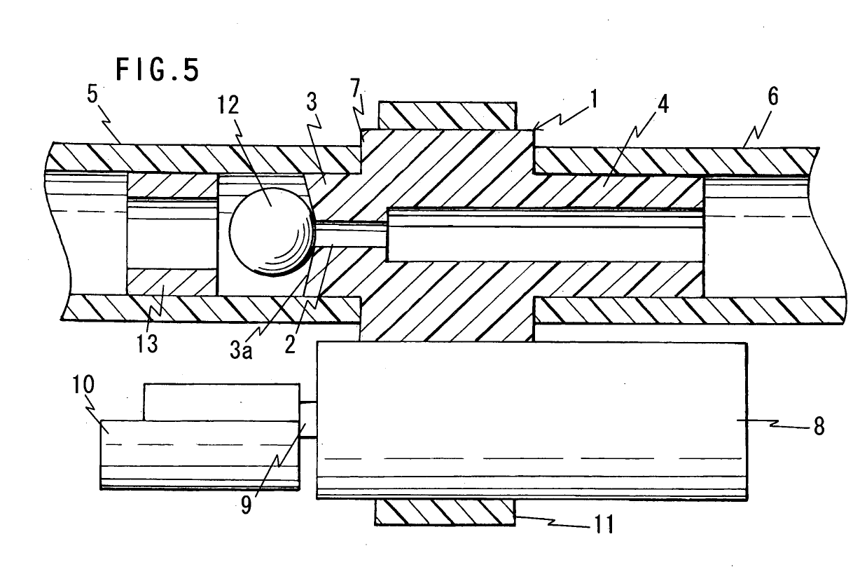

FIG. 5 is a sectional view of the flow control valve according to the present invention achieved in another embodiment. The embodiment is characterized in that a contact surface 3a of the valve seat 3, which comes in contact with the valve element 12, is formed in a tapered shape. Other structural features are identical to those shown in FIGS. 1 and 2. By forming the contact surface 3a of the valve seat 3, which comes in contact with the valve element 12, in a tapered shape as described above, it is ensured that the valve element 12 in contact with the central area of the contact surface 3a in the valve closed state does not readily move away from the valve hole 2 even in the event of an external disturbance. Furthermore, while the structure requires a slightly higher level of drive force to open the valve, the valve closed state can be sustained with better stability. Moreover, even if the valve element 12 moves away from the valve hole 2, the valve element 12 promptly returns to the valve hole 2 as soon as the eccentric rotation of the valve element 12 stops. In other words, the valve element 12 moves back toward the valve hole to restore the closed state promptly.

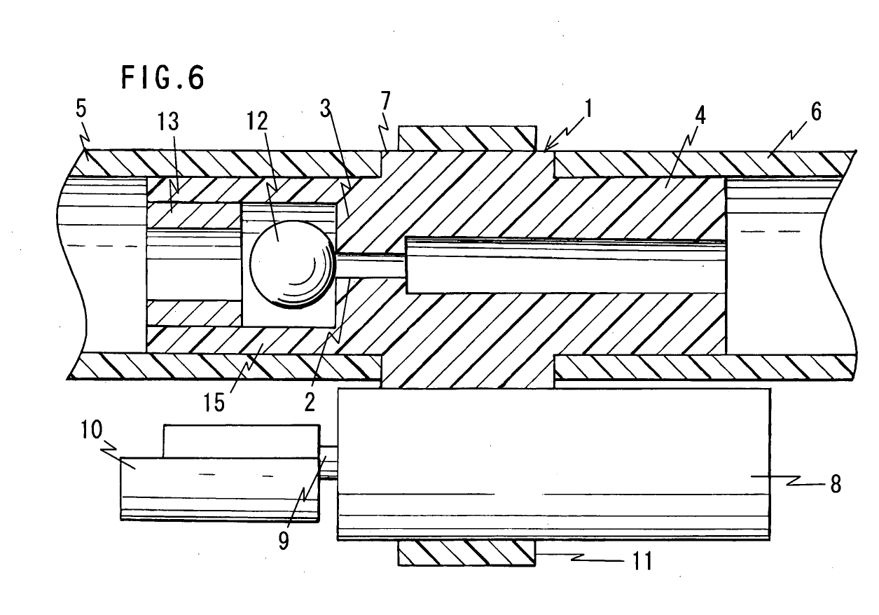

FIG. 6 presents a sectional view of the flow control valve according to the present invention achieved in yet another embodiment. The embodiment is characterized in that a pipeline 15 housing the valve element 12 and having the stopper 13 disposed therein is fixed inside the valve main unit 1. Other structural features are identical to those shown in FIGS. 1 and 2. In the embodiment, the stopper 13, fixed to the valve main unit 1, does not become misaligned even after an extended period of use. Moreover, since the valve main unit 1 is constituted of a rigid material such as a hard resin, the correct positional relationship between the valve element 12 and the valve seat 3 can be sustained for a long time with a high level of stability.

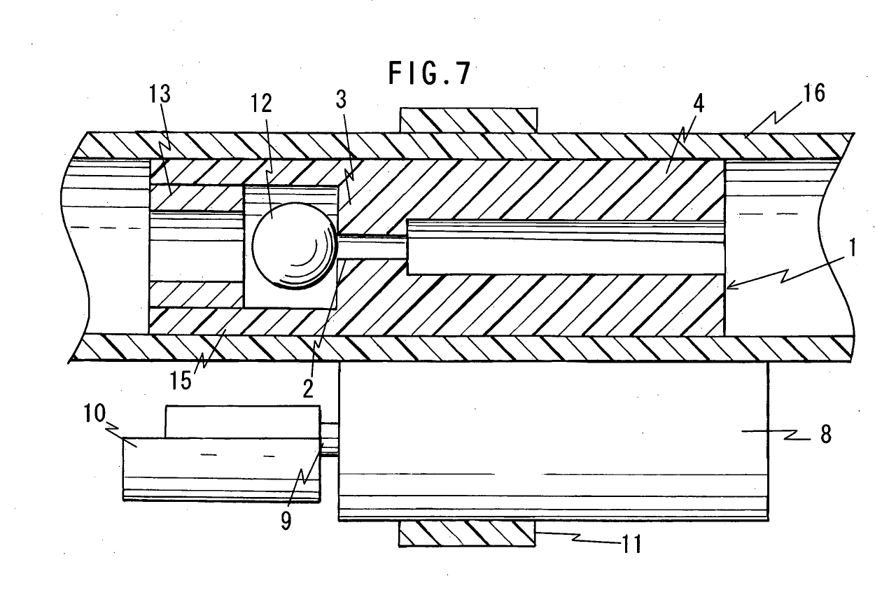

FIG. 7 presents a sectional view of the flow control valve according to the present invention achieved in a further embodiment. The embodiment is characterized in that the valve main unit 1, which includes the valve element 12 and the stopper 13, is housed inside a pipeline 16 through which the fluid flows. The vibrating motor 8 is mounted outside the pipeline 16 via a band 11. Since the structure achieved in the embodiment does not require any direct coupling between the pipeline 16 and the valve main unit 1, fluid leakage at the flow control valve can be completely prevented.

The present invention allows for various modifications to the embodiments described above with regard to the structures of the valve main unit 1, the valve seat 3 and the stopper 13, the positional arrangement of these members and the structure adopted in combining these members with the valve element 12, as long as the teaching of the present invention is not compromised.

1. A flow control valve comprising:
a valve seat disposed inside a pipeline through which a fluid flows;
a spherical valve element housed inside said pipeline and assuming a diameter smaller than the inner diameter of said pipeline, with which a valve hole at said valve seat can be closed or opened; and
a rotational drive device disposed outside said pipeline which opens said valve hole at said valve seat by causing eccentric rotational of said valve element kept in contact with an inner wall of said pipeline.

2. A flow control valve according to claim 1, wherein:
said rotational drive device is constituted with a vibrating motor that causes eccentric rotation of said valve element by eccentrically rotating said pipeline.

3. A flow control valve according to claim 1, further comprising:
a stopper disposed inside said pipeline that regulates a distance by which said valve element is set apart from said valve seat.

4. A flow control valve according to claim 1, wherein:
said rotational drive device is constituted with a vibrating motor that causes eccentric rotation of said valve element by eccentrically rotating said pipeline; and further comprising:
a stopper disposed inside said pipeline that regulates a distance by which said valve element is set apart from said valve seat.
